(19) United States
(12) Patent Application Publication
(10) Pub. No.: US 2010/0070254 A1
(43) Pub. Date: Mar. 18, 2010

(54) Method for Generating Real-Time Haptic Response Information for a Haptic Simulating Device

(75) Inventors: Ming-Dar Tsai, Taipei City (TW); Ming-Shium Hsieh, Taipei City (TW)

Correspondence Address: GROSSMAN, TUCKER, PERREAULT & PFLEGER, PLLC, 55 SOUTH COMMERICAL STREET, MANCHESTER, NH, 03101, US

(73) Assignees: Chung Yuan Christian University, Chung Li (TW); Taipei Medical University, Taipei City (TW)

(21) Appl. No.: 12/559,607

(22) Filed: Sep. 15, 2009

(30) Foreign Application Priority Data
Sep. 16, 2008 (TW) 097135463

(51) Int. Cl. G06G 7/48; G06T 17/00; G09G 5/00

(52) U.S. Cl. 703/11; 345/424; 345/156

(57) ABSTRACT

A method is provided for generating real-time haptic response information for a haptic simulating device during a surgery simulation performed on an object volume by a virtual tool that is associated with the haptic simulating device. The object volume includes tissue voxels, null voxels, and object boundary points located between corresponding adjacent pairs of the tissue and null voxels. The method includes: (a) obtaining a current center position of the virtual tool; (b) determining a current tool subvolume of the object volume; and (c) upon determining that the current tool subvolume has at least one tissue voxel, performing the sub-steps of: (c-1) determining positions of tool boundary points within the current tool subvolume, (c-2) updating labeling of the voxels within the current tool subvolume and replacing an original set of the object boundary points within the current tool subvolume with a new set of the object boundary points, and (c-3) providing force information of a force to be generated by the haptic simulating device.

### CROSS-REFERENCE TO RELATED APPLICATION

This application claims priority of Taiwanese Application No. 097135463, filed on Sep. 16, 2008.

### BACKGROUND OF THE INVENTION

1. Field of the Invention

The invention relates to a haptic response simulation method, more particularly to a method for generating real-time haptic response information for a haptic simulating device during a three-dimensional surgery simulation.

2. Description of the Related Art

Common surgical tools include rotating drills, rotating burs, oscillating saws, etc. Burring operations are implemented for delicate removal of tissues such as bone, tooth, intervertebral disc substance, nasal polyp, etc., or for polishing of bone, tooth and prosthesis. It is not uncommon for this kind of operation to be performed in fine body parts where intricately structured tissues such as brain, nerves and vessels are present. Tactile feelings of reaction forces during surgery help surgeons prevent overcut and obtain higher quality operated surfaces. Therefore, a surgery simulation system for training and rehearsing purposes is expected to demonstrate not only delicate geometric changes but also to provide fine tactile feeling outputs.

At present, polygon models are usually used for tooth burring simulations, where tissue geometry is rather simple, but are difficult to use for burring operations involving more complex tissue geometry.

Conventionally, the marching cubes algorithm is used for generating boundaries between the tissue in question (e.g., bone in bone removal surgery simulation) and other neighboring voxels (e.g., muscle, nerves in bone removal surgery simulation). One conventional volume manipulation technique is called subvoxel technique. During a surgery simulation performed by a virtual tool that is associated with a haptic simulating device on an object volume that includes a plurality of gray-scale voxels (some of which are tissue voxels representing the tissue in question and others are null voxels representing other tissues), a gray-scale value of the voxel is decreased when the voxel is overlapped with the virtual tool, and a voxel is nullified when the gray-scale value thereof is smaller than a predefined threshold value. For example, shown in FIG. 1(a) is a two-dimensional illustration of 25 gray-scale voxels, each of which is represented by a square box having a smaller square therein to represent center of the voxel. Null voxels are represented by white boxes, and tissue voxels are represented by boxes with shadowing lines. The bold curved line indicates the actual boundary of the tissue, which passes through voxels (A) and (B). However, since voxels (A) and (B) have been nullified, and triangles of these voxels (A), (B) used by the marching cubes algorithm for generating the boundary are deleted, there is a great difference between the simulated boundary and the actual boundary.

Moreover, this conventional technique is inaccurate for delicate tissue removal simulations because the virtual tool used therein is usually small in dimension and a feed distance (i.e., travel distance) of the virtual tool during a haptic period is usually very minimal such that the virtual tool may traverse the same voxels in tens of the haptic periods. The conventional technique is unable to detect the changes that occur under this circumstance, and is only able to provide roughly estimated force magnitude (not direction) of a force that is to be generated by the haptic simulating device. With reference again to FIG. 1(a), the only output of the haptic simulating device (not shown) is a center position (C) of the virtual tool 900 associated therewith. However, when only the center position (C) of the virtual tool 900 is used to determine whether the virtual tool 900 is in contact with the tissue, differences in the reaction force components on different geometric structures cannot be precisely demonstrated by the force information thus generated. With reference to FIG. 1(b), where the solid circle represents the virtual tool 900 in the current haptic step (hereinafter indicated by reference numeral 902), and the dashed circle represents the virtual tool 900 in a previous haptic step (hereinafter indicated by reference numeral 901), there has only been a tiny movement of the virtual tool 902, 901 between the current and previous haptic steps, such that the center positions (C) of the virtual tool 902, 901 in the current and previous haptic steps are located in the same voxel. With the conventional technique, this tiny movement cannot be detected so that no accurate geometrical change or force simulation can be provided.

Although voxel interpolation can improve the accuracy of the simulation system, the increases in memory space and computation are significant.

### SUMMARY OF THE INVENTION

Therefore, the object of the present invention is to provide a method for generating real-time haptic response information for a haptic simulating device that can accurately represent delicate tissue removal operations.

According to this invention, there is provided a method for generating real-time haptic response information for a haptic simulating device during a surgery simulation performed on an object volume by a virtual tool that is associated with the haptic simulating device. The object volume is defined in a three-dimensional object coordinate system, and includes a first set of uniformly-spaced-apart voxels. Each of the voxels is labeled as one of a tissue voxel and a null voxel, and has a voxel center position expressed by integer coordinate components in the object coordinate system. The object volume further includes a plurality of object boundary points, each of which is located between a corresponding adjacent pair of the tissue and null voxels.

The method includes the steps of:

(a) obtaining a current center position of the virtual tool in the object coordinate system, the current center position being temporally spaced apart from a previously obtained center position of the virtual tool by a predefined haptic period;

(b) determining a current tool subvolume of the object volume in the object coordinate system based on the current center position of the virtual tool and predefined dimensions of the virtual tool in the object coordinate system; and

(c) upon determining that the current tool subvolume has at least one of the tissue voxels, performing the sub-steps of:
(c-1) determining positions of a plurality of tool boundary points within the current tool subvolume based on the current center position of the virtual tool and the predefined dimensions of the virtual tool,
(c-2) updating labeling of the voxels within the current tool subvolume and replacing an original set of the object boundary points within the current tool subvolume with a new set of the object boundary points with reference to the positions of the tool boundary points determined in sub-step (c-1) and the voxel center positions of at least one of the tissue and null voxels within the current tool subvolume, and
(c-3) providing force information of a force to be generated by the haptic simulating device according to a feed direction from the previously obtained center position of the virtual tool to the current center position of the virtual tool, a feed distance between the current and previously obtained center positions of the virtual tool, the predefined dimensions of the virtual tool, a relationship between the positions of the tool boundary points and the voxels within the current tool subvolume, and a predefined force parameter set.

The present invention provides a method that is more efficient and that is more accurate as compared to the prior art in providing force information of the force to be generated by the haptic simulating device with reference to the positions of the tool boundary points and the voxels within the current tool subvolume while taking into account the feed direction and the feed rate of the virtual tool within the predefined haptic period.

### BRIEF DESCRIPTION OF THE DRAWINGS

Other features and advantages of the present invention will become apparent in the following detailed description of the preferred embodiment with reference to the accompanying drawings, of which:

FIG. 1(a) is a schematic diagram of a two-dimensional illustration of 25 gray-scale voxels of the prior art;

FIG. 1(b) is a schematic diagram, illustrating that center positions of a virtual tool in a current haptic step and a previous haptic step are located in the same voxel in the prior art;

FIG. 2 is a schematic diagram for illustrating the environment of using a simulation system according to the preferred embodiment of the present invention;

FIG. 3 is a block diagram of a program module, a display screen and a haptic simulating device of the simulation system;

FIG. 4 is a flowchart, illustrating the method for generating real-time haptic response information according to the preferred embodiment;

FIG. 5 is a schematic diagram, illustrating determination of a current tool subvolume in step 403;

FIG. 6 is a schematic diagram, illustrating determination of tool boundary points in step 406;

FIGS. 7(a)˜7(c) are schematic diagrams for illustrating a tool extent, a boundary tissue extent and an interior tissue extent;

FIG. 8 contains schematic diagrams (a)˜(d), respectively illustrating four possible cases during determination of replacement/removal of voxels and object boundary points when a leftmost tool boundary point is used as the reference for determination;

FIG. 9 contains schematic diagrams (a)˜(d), respectively illustrating four possible cases during determination of replacement/removal of the voxels and the object boundary points when a rightmost tool boundary point is used as the reference for determination;

FIG. 10 is a schematic diagram, illustrating another case during determination of replacement/removal of the voxels and the object boundary points;

FIG. 11 is a schematic diagram for illustrating a relationship between distance-level values and position of a new object boundary point that is originally a tool boundary point;

FIG. 12 is a flowchart, illustrating sub-steps of step 408 of the method for generating real-time haptic response information according to the preferred embodiment;

FIG. 13(a) is a schematic diagram, illustrating a device coordinate system of the haptic simulating device;

FIG. 13(b) and FIG. 13(c) are schematic diagrams, illustrating determination of a surface element and four element sub-components of an element force component;

FIG. 14 contains three diagrams (a)˜(c), respectively illustrating front, side and top views of image construction of an object volume in the exemplary application;

FIG. 15 contains six diagrams (a)˜(f), respectively being enlarged views of third and fourth cervical vertebra (C3, C4) in the image construction of FIG. 14(a) during tissue removal performed by a virtual tool;

FIG. 16 contains three graphs (a)˜(c), respectively showing strengths of three directional force components F_{X}, F_{Y}, F_{Z} of a force to be generated by the haptic simulating device during tissue removal by a large bur;

FIG. 17 contains three graphs (a)˜(c), respectively showing strengths of three directional force components F_{X}, F_{Y}, F_{Z} of a force to be generated by the haptic simulating device during tissue removal by a large bur; and

FIG. 18 is a schematic diagram, illustrating determination of a tool swept subvolume according to other embodiments of the present invention.

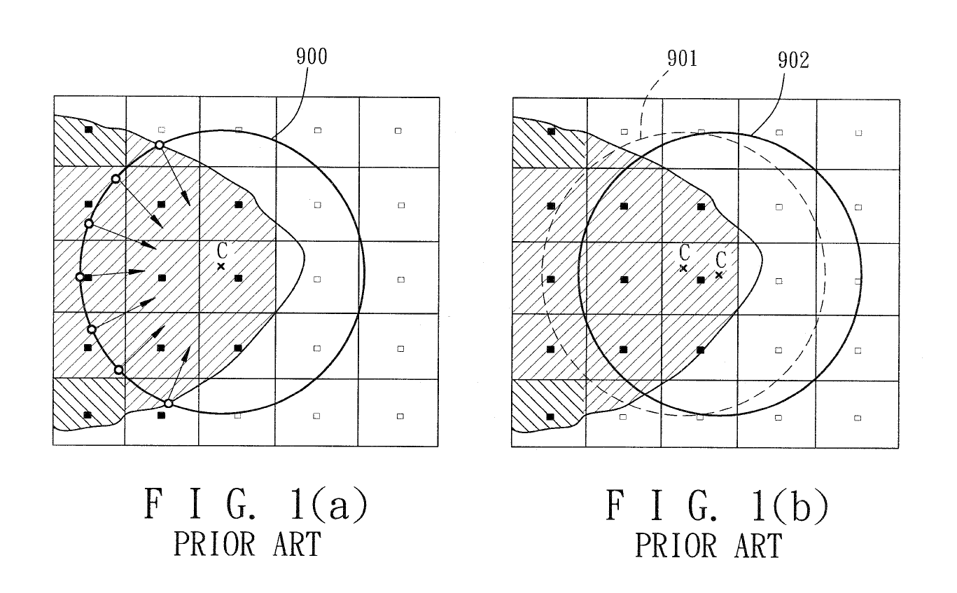

### DETAILED DESCRIPTION OF THE PREFERRED EMBODIMENT

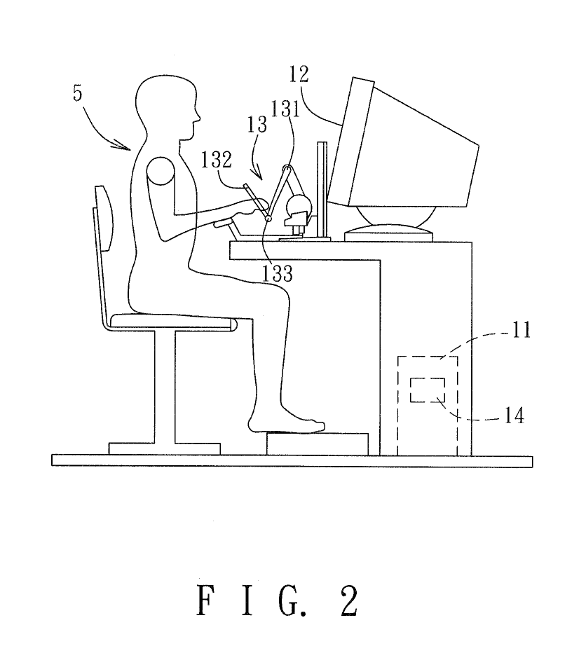

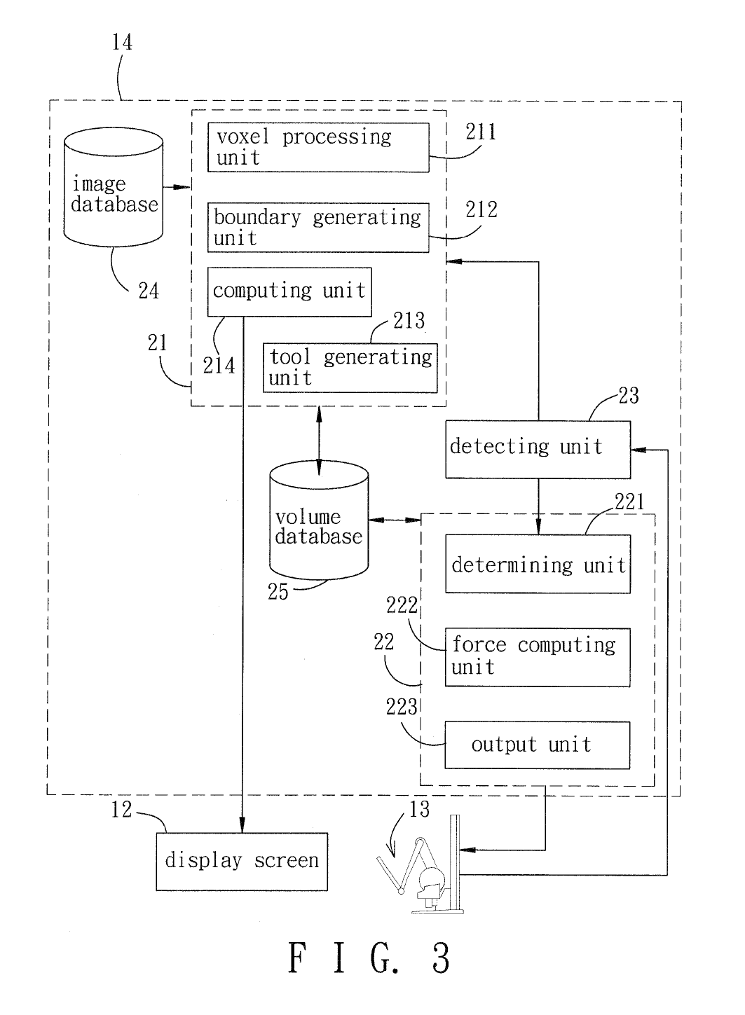

Referring to FIG. 2(a), a simulation system according to the preferred embodiment of the present invention is shown to include a computing apparatus 11, and a display screen 12 and a haptic simulating device 13 coupled electrically to the computing apparatus 11. The haptic simulating device 13 can be, for example, PHANTOM® Desktop Haptic Device by SensAble technologies, and includes a haptic arm 131, a handle 132, and a sensing ball 133. The haptic simulating device 13 provides a current center position of the sensing ball 133 to the computing apparatus 11. The current center position of the sensing ball 133 is the current center position of a virtual tool, and is expressed in a three-dimensional (3D) object coordinate system. The object coordinate system is defined by first, second and third axes (X, Y, Z) that are orthogonal to each other. During a surgery simulation performed by the virtual tool that is associated with the haptic simulating device 13 on a 3D object volume that includes a plurality of uniformly-spaced-apart voxels, the handle 132 is held by a user 5 in order to move the sensing ball 133, and a force is generated by the haptic simulating device 13 and fed back via the haptic arm 131 and the handle 132 and felt by the user 5 so as to provide haptic response. Each of the voxels is labeled as one of a tissue voxel and a null voxel, and has a voxel center position expressed by integer coordinate components in the object coordinate system. The object volume further includes a plurality of object boundary points, each of which is located between a corresponding adjacent pair of the tissue and null voxels.

The method for generating real-time haptic response information for the haptic simulating device 13 during the surgery simulation according to the present invention is implemented by the computing apparatus 11 as configured by a program module 14 to provide force information related to strength and direction of the force to be generated by the haptic simulating device 13. It should be noted herein that the computing apparatus 11 not controls the haptic response, but also controls visual response for the surgery simulation so as to provide the most realistic surgery environment for the user 5. In particular, due to persistence of vision, refreshing rate of visual response (i.e., image display on the display screen 12) is approximately 15 times per second in order for the user 5 to obtain continuous visual sensing. On the other hand, the lowest acceptable refreshing rate for haptic response (i.e., force feedback by the haptic simulating device 13) is approximately 1000 times per second in order for the user 5 to obtain a continuous tactile feeling. Due to the difference in refreshing rates, two separate execution threads are used for visual response processing and haptic response processing.

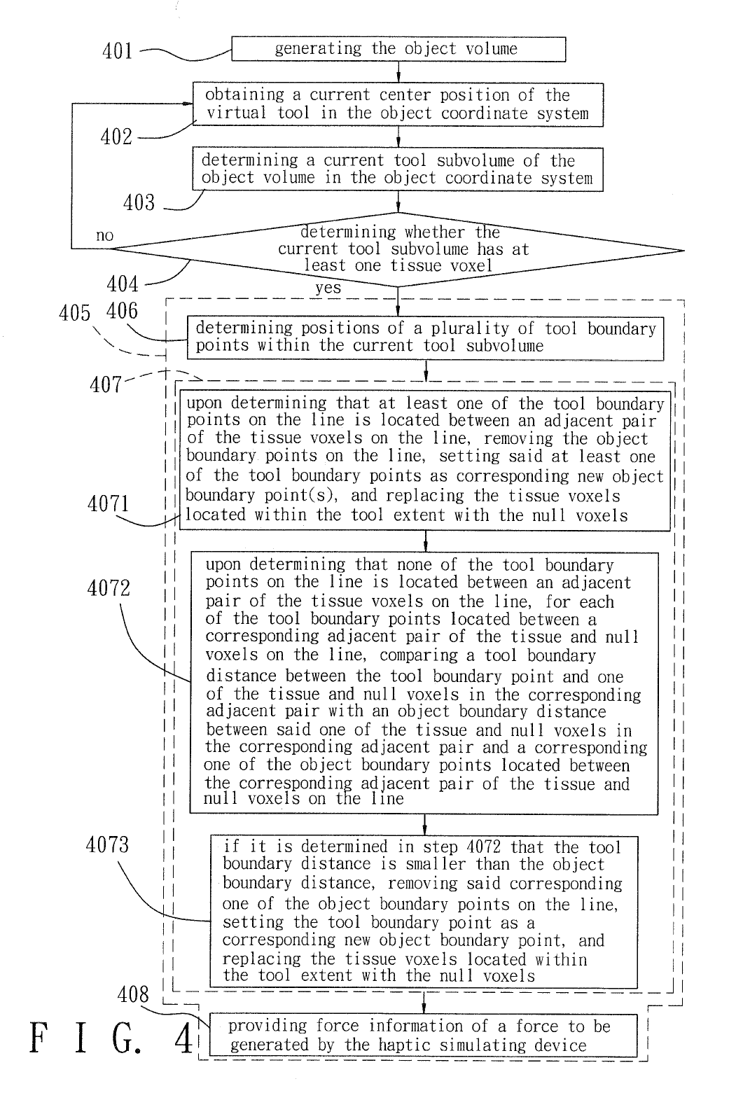

Referring to FIG. 3, the program module 14 includes a display module 21, a haptic response module 22, a detecting unit 23, an image database 24, and a volume database 25.

The image database 24 contains a plurality of image data sets. The image data sets correspond to pixels in two-dimensional (2D) image slices obtained from CAT-scan (CT) or magnetic resonance imaging (MRI) (and possibly other image slices generated by linear interpolation based on the image slices obtained from CT or MRI), and correspond to voxels in the object volume. Each of the image data sets contains a first-axis coordinate component, a second-axis coordinate component, a third-axis coordinate component, and a gray-scale value. The first, second and third-axis coordinate components are integer coordinate components, and cooperate to indicate the voxel center position of the corresponding one of the voxels.

The detecting unit 23 is coupled to the haptic simulating device 13, and is capable of obtaining operating information of the haptic simulating device 13 therefrom. The operating information includes the current center position of the sensing ball 133 (i.e., the current center position of the virtual tool), predefined dimensions of the virtual tool, and a current status of the virtual tool. In case of a burring surgery, where the virtual tool is a ball-shaped rotatable burring tool, the current status is one of rotating and non-rotating.

The display module 21 is in communication with the image database 24, the volume database 25, the detecting unit 23, and the display screen 12. The display module 21 constructs a 3D visual output of the object volume with reference to the image data sets recorded in the image database 21 for display on the display screen 12. The display module 12 includes a voxel processing unit 211, a boundary generating unit 212, a tool generating unit 213, and a computing unit 214.

The voxel processing unit 211 converts the image data sets into voxel data sets that are to be stored in the volume database 25. In particular, for each of the image data sets, the voxel processing unit 211 determines a voxel label, indicating the corresponding one of the voxels to be one of the tissue and null voxels, by comparing the gray-scale value corresponding to the voxel represented by the image data set with a predefined threshold value, and stores the first, second and third-axis coordinate components along with the voxel label as a corresponding voxel data set into the volume database 25. The voxel processing unit 211 further determines, for the voxel data set that corresponds to each of the voxels in an adjacent pair of the tissue and null voxels, a distance-level value according to gray-scale values of the adjacent pair of the tissue and null voxels based on the following equation:

$$d = ( \frac{sl - T}{sl - sm} )$$

where d represents the distance-level value, sl represents the gray-scale value corresponding to the corresponding voxel of the corresponding adjacent pair of the tissue and null voxels, sm represents the gray-scale value corresponding to the other one of the voxels in the corresponding adjacent pair of the tissue and null voxels, and T represents the predefined threshold value. The distance-level value indicates a distance between the voxel center position of the corresponding voxel in the adjacent pair of the tissue and null voxels and the corresponding object boundary point that is located between the corresponding adjacent pair of the tissue and null voxels in a corresponding one of six directions (±X, ±Y, ±Z) along the first, second and third axes (X, Y, Z). The distance-level value ranges from 0 to 1, and is stored in the volume database 25.

It should be noted herein that the surgery simulation is bone burring surgery simulation in this embodiment. Therefore, the tissue voxel represents bone, and the null voxel represents other tissues such as fat, muscle, nerves, etc. Moreover, since the object boundary points only exist between adjacent pairs of the tissue and null voxels, the distance level values are only computed for the voxels in the adjacent pairs of the tissue and null voxels. In addition, a voxel data set may have a maximum of six distance-level values, respectively representing the location of the object boundary points in the six directions (±X, ±Y, ±Z).

The boundary information generating unit 212 generates boundary surface information for the tissue (i.e., bone in this embodiment) with reference to the object boundary points according to the marching cubes algorithm, where cubes that are defined by 8 neighboring voxels, at least one of which is a tissue voxel, are allocated to find polygon surface information (or iso-surface information) that are later combined to form the boundary surface information.

The tool information generating unit 213 is used for generating display information regarding the virtual tool that is associated with the haptic simulating device 13 with reference to the current center position of the sensing ball 133 (i.e., the current center position of the virtual tool) as obtained from the haptic simulating device 13 through the detecting unit 23 and predefined dimensions of the virtual tool.

In each visual step (at a rate of approximately 15 visual steps per second), the computing unit 214 generates a visual display of the tissue and the virtual tool to be displayed on the display screen 12 with reference to the boundary surface information for the tissue and the display information regarding the virtual tool as generated by the boundary information generating unit 212 and the tool information generating unit 213.

During actual implementation, since the feed distance between the current center position of the virtual tool and a previously obtained center position of the virtual tool temporally spaced apart from the current center position by a predefined haptic period is very small, changes made to the object volume due to the feed of the virtual tool are very slight as well. Therefore, in order to save computation time, a subvolume is defined to enclose the virtual tool for computation of the changes made to the object volume. Moreover, for visual construction of the object volume in each visual step, only the subvolume is reconstructed, while the other parts of the object volume are not reconstructed. Details regarding the subvolume will be disclosed later.

The haptic response module 22 is in communication with the detecting unit 23, the volume database 25, and the haptic simulating device 13, and includes a determining unit 221, a force computing unit 222, and an output unit 223.

In each haptic step (at a rate of approximately 1000 haptic steps per second, the predefined haptic period being inversely proportional to the rate), the determining unit 221 determines the changes made to the object volume by the feed of the virtual tool, and updates the volume database 25.

The force computing unit 222 computes force information of a force to be generated by the haptic simulating device 13 with reference to the feed. Details of how the force information is generated will be disclosed later.

The output unit 223 outputs a control command to the haptic simulating device 13 for the haptic simulating device 13 to generate the force according to the control command.

With reference to FIG. 4, detailed steps of the method for generating real-time haptic response information for the haptic simulating device 13 during a surgery simulation performed on a object volume by a virtual tool that is associated with the haptic simulating device 13 according to the preferred embodiment of the present invention are disclosed.

In step 401, the object volume is generated based on the volume database 25 that contains a plurality of voxel data sets, each of which represents a corresponding one of the voxels in the object volume, and contains a first-axis coordinate component, a second-axis coordinate component, a third-axis coordinate component, and a voxel label. The first, second and third-axis coordinate components cooperate to indicate the voxel center position of the corresponding one of the voxels. The voxel label indicates the corresponding one of the voxels to be one of the tissue and null voxels.

In step 402, a current center position of the virtual tool (i.e., the current center position of the sensing ball 133) is obtained in the object coordinate system. The current center position is temporally spaced apart from a previously obtained center position of the virtual tool by a predefined haptic period. It should be noted herein that the current center position of the virtual tool is in reality expressed in a three-dimensional device coordinate system, and a conversion into the object coordinate system is required.

In step 403, a current tool subvolume of the object volume is determined in the object coordinate system based on the current center position of the virtual tool and predefined dimensions of the virtual tool in the object coordinate system.

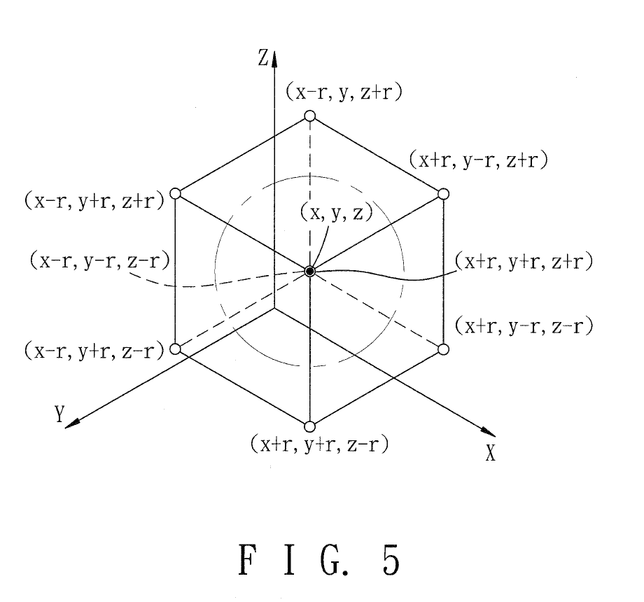

In this embodiment, the current tool subvolume has the shape of a rectangular parallelepiped, and is determined by finding boundary of the smallest cuboid that encloses the virtual tool, and the boundary is then enlarged to have integer coordinate components while still enclosing the virtual tool. With reference to FIG. 5, assuming that the virtual tool 501 is a rotatable ball-shaped burring tool, and has a radius of (r) and a current center position that is located at (x, y, z), then the boundary of the smallest cuboid 502 is defined by points (x−r, y−r, z−r), (x−r, y−r, z+r), (x−r, y+r, z−r), (x−r, y+r, z+r), (x+r, y−r, z−r), (x+r, y−r, z+r), (x+r, y+r, z−r) and (x+r, y+r, z+r). If these points are all expressed in integer coordinate components, they cooperate to define the current tool subvolume, i.e., voxels whose center positions fall within the confines defined by these points are considered to be within the current tool subvolume. On the other hand, if at least one of these points is not expressed in integer coordinate components, the coordinate components are rounded up/down in order to find a larger cuboid that has integer coordinate components and that encloses the virtual tool 501. For example, the coordinate components of the points defining the current tool subvolume may have first-axis coordinate components of (└x-r┘), (┌x+r┐), second-axis coordinate components of (└y−r┘), (┌y+r┐), and third-axis coordinate components of (└z−r┘), (┌z+r┐), where └A┘ represents a mathematical operation for rounding (A) down to the nearest integer, and ┌A┐ represents a mathematical operation for rounding (A) up to the nearest integer.

In step 404, it is determined whether the current tool subvolume has at least one of the tissue voxels. If it is determined that the current tool subvolume has at least one of the tissue voxels, the flow goes to step 405; otherwise, the flow goes back to step 402.

Step 405 includes three sub-steps: step 406, step 407 and step 408.

In step 406, positions of a plurality of tool boundary points within the current tool subvolume are determined based on the current center position of the virtual tool and the predefined dimensions of the virtual tool.

In particular, the position of each of the tool boundary points is determined by locating a corresponding intersection between an outer surface of the virtual tool that is determined from the current center position of the virtual tool and the predefined dimensions of the virtual tool, and a corresponding line that is parallel to one of the first, second and third axes (X, Y, Z), and that has integer coordinate components in the other two of the first, second and third axes (X, Y, Z). A line segment bounded by two of the tool boundary points respectively having the greatest and smallest coordinate component values in said one of the first, second and third axes (X, Y, Z) that the line segment is parallel to is defined as a tool extent.

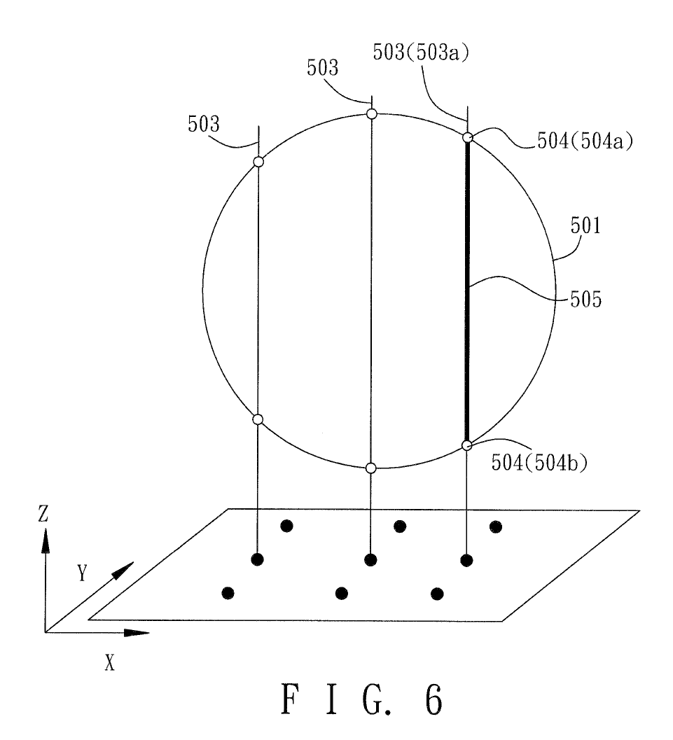

With reference to FIG. 6, assuming that an area the current tool subvolume projected on a plane formed by the first and second axes (X, Y) encloses center positions of nine voxels, then there are nine lines 503 parallel to the third axis (Z) for determining the positions of the tool boundary points 504 with integer coordinate components in the first and second axes (X, Y) and unknown third axis (Z) coordinate components that are to be determined by locating intersections between the outer surface of the virtual tool 501 and the lines 503. In addition, for each of these lines 503, taking line 503a as an example, the line segment bounded by two of the tool boundary points 504a, 504b respectively having the greatest and smallest coordinate component values in the third axis (Z) is defined as a tool extent 505.

In step 407, labeling of the voxels within the current tool subvolume are updated, and an original set of the object boundary points within the current tool subvolume is replaced with a new set of the object boundary points with reference to the positions of the tool boundary points determined in step 406, and the voxel center positions of at least one of the tissue and null voxels within the current tool subvolume.

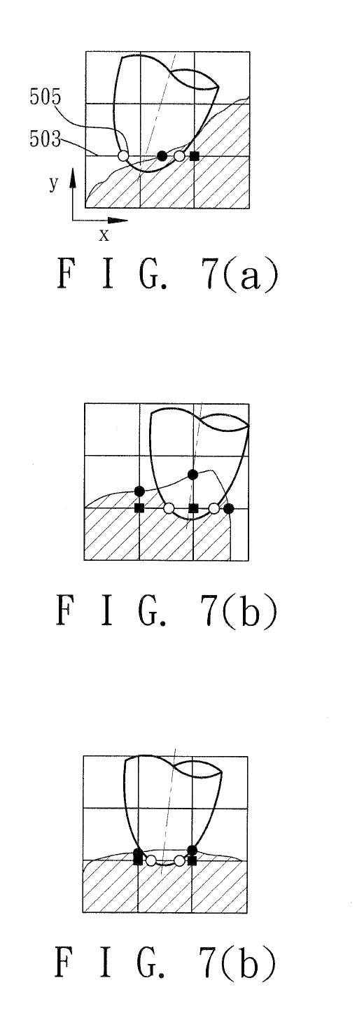

Step 407 is performed to manipulate the object volume and update the volume database 25 by determining what changes are made to the object volume by the virtual tool (i.e., which tissues are removed by the virtual tool) in this haptic step. In particular, for each of the lines defined in step 406, a line segment bounded by one of the object boundary points and one of the tissue voxels is defined as a boundary tissue extent, and a line segment bounded by two of the tissue extents is defined as an interior tissue extent. In FIGS. 7(a), 7(b) and 7(c), a solid square (▪) represents a tissue voxel, a solid circle () represents an object boundary point, and a hollow circle (∘) represents a tool boundary point. Referring to FIG. 7(a), on the line 503, the tool extent 505 overlaps part of a boundary tissue extent. This means that the virtual tool removes the tissue within this part of the boundary tissue extent. Referring to FIG. 7(b) and FIG. 7(c), the tool extent overlaps part of an interior tissue extent. This means that the virtual tool removes the tissue within this part of the interior tissue extent. Details regarding how to update the labeling of the voxels within the current tool subvolume, and how to find the new set of the object boundary points will be described next.

Step 407 includes three sub-steps, i.e., step 4071, step 4072, and step 4073, that are conducted with respect to each of the lines that correspond to the tool boundary points.

In step 4071, upon determining that at least one of the tool boundary points on the line is located between an adjacent pair of the tissue voxels on the line, the object boundary points on the line are removed, said at least one of the tool boundary points is (are) set as corresponding new object boundary point (s), and the tissue voxels located within the tool extent are replaced with the null voxels. An example of the above case is illustrated in FIG. 10.

In step 4072, upon determining that none of the tool boundary points on the line is located between an adjacent pair of the tissue voxels on the line, for each of the tool boundary points located between a corresponding adjacent pair of the tissue and null voxels on the line, a tool boundary distance (b) between the tool boundary point and one of the tissue and null voxels in the corresponding adjacent pair is compared with an object boundary distance (b′) between said one of the tissue and null voxels in the corresponding adjacent pair and a corresponding one of the object boundary points located between the corresponding adjacent pair of the tissue and null voxels on the line.

In step 4073, if it is determined in step 4072 that the tool boundary distance is smaller than the object boundary distance, said corresponding one of the object boundary points on the line is removed, the tool boundary point is set as a corresponding new object boundary point, and the tissue voxels located within the tool extent is replaced with the null voxels.

In a simpler implementation, not every tool boundary point in the line has to be used for the above determination.

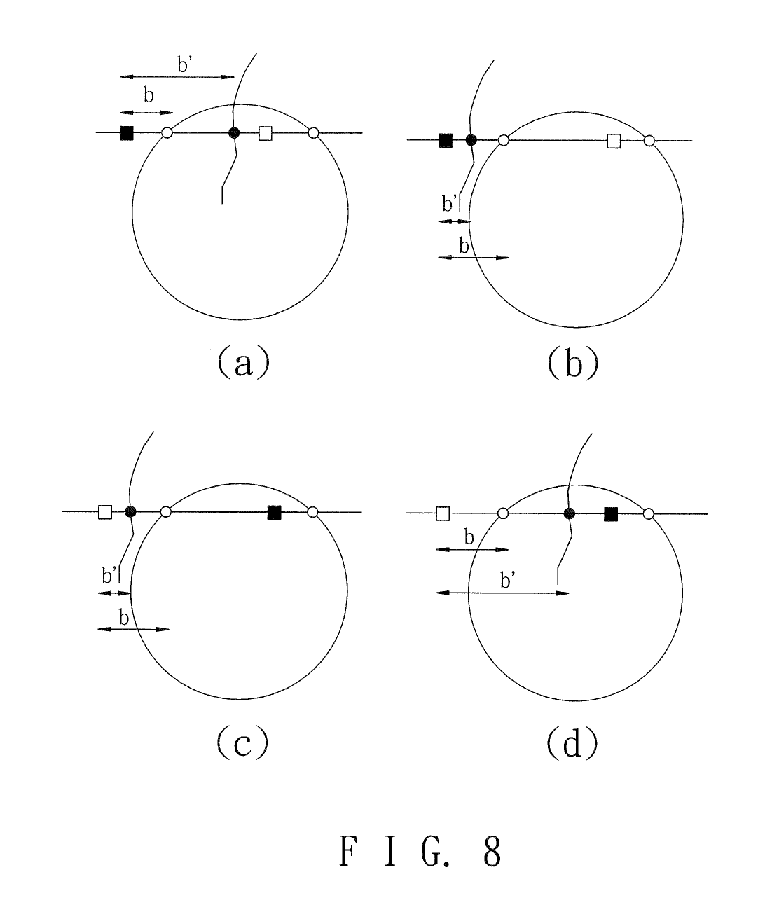

With reference to FIG. 8, for each axis-parallel line, the tool boundary point with the smallest coordinate component in the axis (hereinafter referred to as the “leftmost tool boundary point”), and the tissue/null voxel in the corresponding adjacent pair with the smallest coordinate component in the axis (hereinafter referred to as the “leftmost voxel”) are used to define the tool boundary distance (b), and the leftmost voxel and the object boundary point located between the corresponding adjacent pair (hereinafter referred to as the “original object boundary point”) are used to define the object boundary distance (b′). With the tool boundary distance (b) and the object boundary distance (b′) defined as described above, replacement/removal of the voxels and object boundary points on the line can be categorized into four different cases. As shown in FIG. 8(a), where the leftmost voxel is a tissue voxel, and the tool boundary distance (b) is smaller than the object boundary distance (b′), the original boundary point is removed, and the leftmost tool boundary point is set as a corresponding new object boundary point. As shown in FIG. 8(b), where the leftmost voxel is a tissue voxel, and the tool boundary distance (b) is greater than the object boundary distance (b′), indicating that the tool extent does not overlap any part of the boundary tissue extent, no replacement/removal of voxels or object boundary points is necessary. As shown in FIG. 8(c), where the leftmost voxel is a null voxel, and the tool boundary distance (b) is greater than the object boundary distance (b′), all tissue voxels located within the tool extent are replaced with the null voxels, the original boundary point is removed, and the tool boundary point defining the tool extent and having the greatest coordinate component in the axis (hereinafter referred to as the “rightmost tool boundary point”) is set as a corresponding new object boundary point.

As shown in FIG. 8(d), where the leftmost voxel is a null voxel, and the tool boundary distance (b) is smaller than the object boundary distance (b′), all tissue voxels located within the tool extent are replaced with the null voxels, the original boundary point is removed, and the rightmost tool boundary point is set as a corresponding new object boundary point.

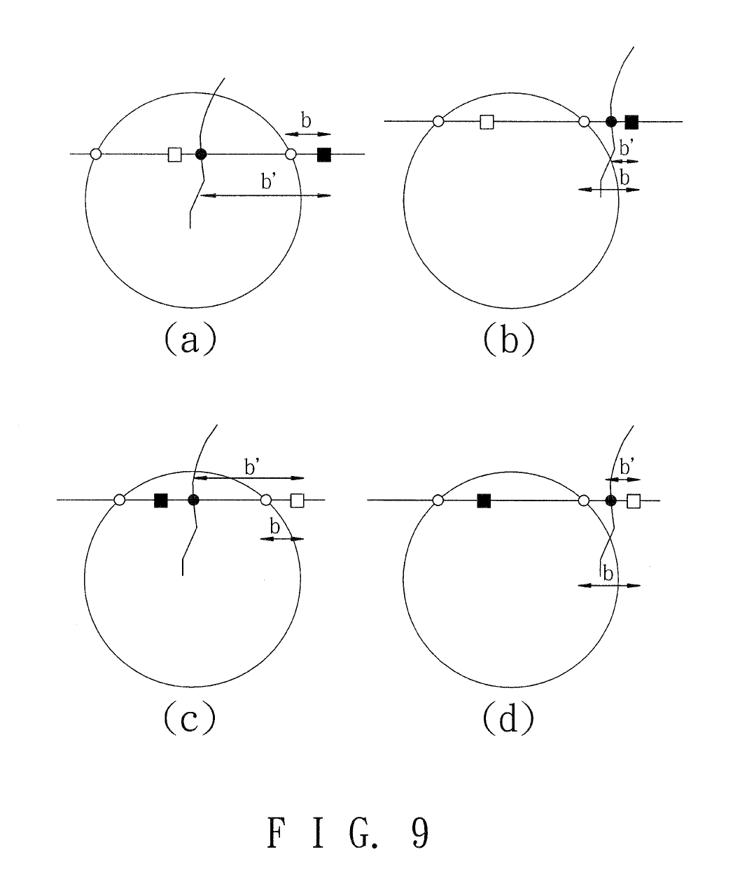

In another implementation, with reference to FIG. 9, for each axis-parallel line, the rightmost tool boundary point, and the rightmost voxel in the corresponding adjacent pair of tissue and null voxels are used to define the tool boundary distance (b), and the rightmost voxel and the object boundary point located between the corresponding adjacent pair (hereinafter referred to as the “original object boundary point”) are used to define the object boundary distance (b′). With the tool boundary distance (b) and the object boundary distance (b′) defined as described above, replacement/removal of the voxels and object boundary points on the line can also be categorized into four different cases. As shown in FIG. 9(a), where the rightmost voxel is a tissue voxel, and the tool boundary distance (b) is smaller than the object boundary distance (b′), the original boundary point is removed, and the rightmost tool boundary point is set as a corresponding new object boundary point. As shown in FIG. 9(b), where the rightmost voxel is a tissue voxel, and the tool boundary distance (b) is greater than the object boundary distance (b′), indicating that the tool extent does not overlap any part of the boundary tissue extent, no replacement/removal of voxels or object boundary points is necessary. As shown in FIG. 9(c), where the rightmost voxel is a null voxel, and the tool boundary distance (b) is smaller than the object boundary distance (b′), all tissue voxels located within the tool extent are replaced with the null voxels, the original boundary point is removed, and the leftmost tool boundary point is set as a corresponding new object boundary point. As shown in FIG. 9(d), where the rightmost voxel is a null voxel, and the tool boundary distance (b) is greater than the object boundary distance (b′), all tissue voxels located within the tool extent are replaced with the null voxels, the original boundary point is removed, and the leftmost tool boundary point is set as a corresponding new object boundary point.

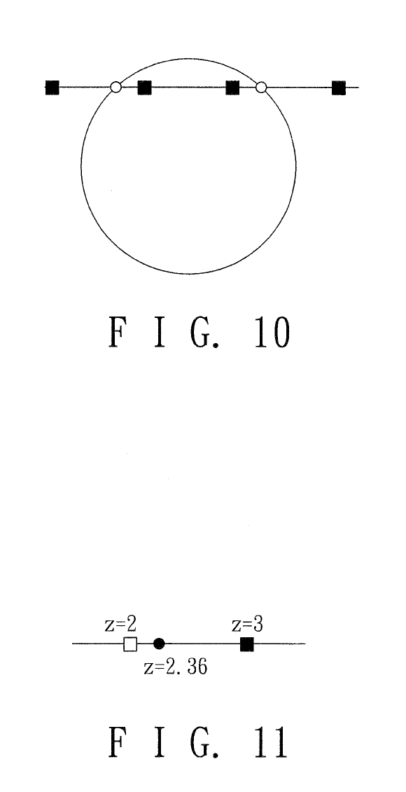

In each of steps 4071 and 4073, each of the voxel data sets corresponding to one of the voxels in a corresponding adjacent pair of the tissue and null voxels that have the new object boundary point located therebetween is assigned with a new distance-level value based on the distance between the new object boundary point and said one of the voxels in a corresponding one of the six directions. In this embodiment, the new distance-level can be determined easily from the non-integer coordinate component of the new object boundary point (old tool boundary point). For example, with reference to FIG. 11, the third-axis coordinate component of the new object boundary point is 2.36, so the distance level of the voxel in the corresponding adjacent pair of the tissue and null voxels with the smaller third-axis coordinate component in the (+Z) direction is the decimal number 0.36 of the third-axis coordinate component of the new object boundary point. On the other hand, the distance level of the voxel in the corresponding adjacent pair of the tissue and null voxels with the bigger third-axis coordinate component in the (−Z) direction is one minus the decimal number 0.36 of the third-axis coordinate component of the new object boundary point.

In step 408, force information of a force to be generated by the haptic simulating device 13 is provided according to a feed direction from the previously obtained center position of the virtual tool to the current center position of the virtual tool, a feed distance between the current and previously obtained center positions of the virtual tool, the predefined dimensions of the virtual tool, a relationship between the positions of the tool boundary points and the voxels within the current tool subvolume, and a predefined force parameter set.

In this embodiment, since the virtual tool associated with the haptic simulating device 13 is a ball-shaped rotatable burring tool, in step 402, a current status of the virtual tool, being one of rotating and non-rotating, is obtained along with the current center position, and steps 406˜408, are performed only if the current status of the virtual tool is rotating because bone is a very hard tissue, and can only be removed when the burring tool is rotating.

If the current status of the virtual tool is non-rotating, and the current tool subvolume is determined to have at least one of the tissue voxels, force information of a force that is to be generated by the haptic simulating device 13 in a direction opposite to the feed direction and that has a predefined strength is provided. This force is a repulsive force provided to notify the user 5 (as shown in FIG. 2) that the virtual tool is in contact with the tissue. Preferably, steps 406˜408 are performed only if the current status of the virtual tool is rotating, and if the feed distance is smaller than a feed distance threshold value. This is because even when the virtual tool is rotating, the bone cannot be removed if the feed distance is too large (i.e., a feed rate is too high).

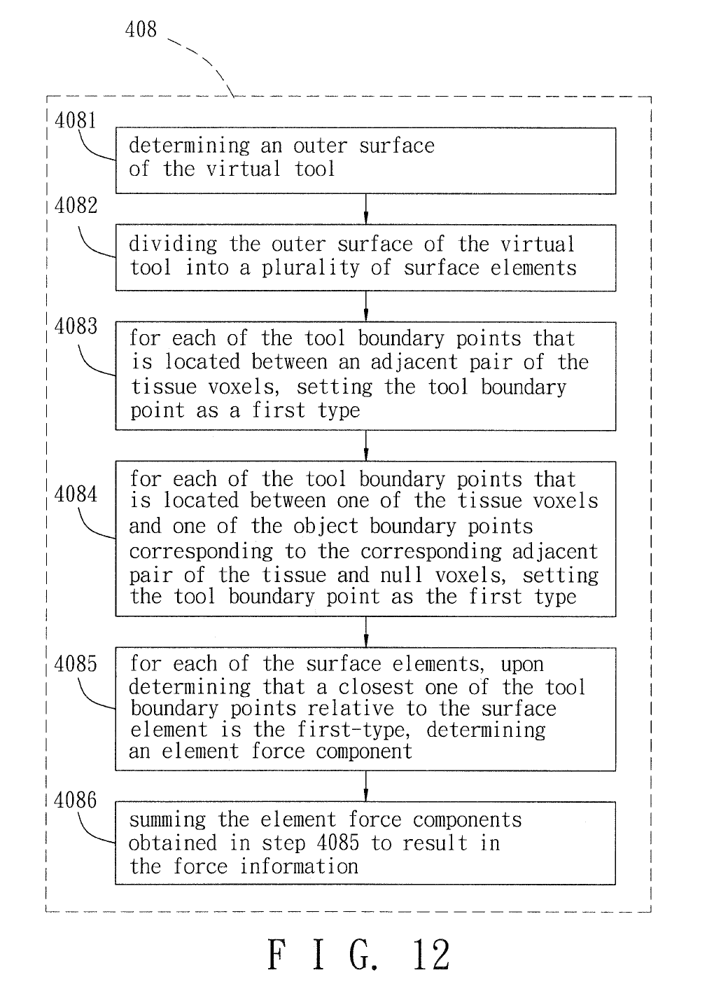

With reference to FIG. 12, step 408 includes the following sub-steps in this embodiment.

In step 4081, an outer surface of the virtual tool is determined according to the current center position of the virtual tool and the predefined dimensions of the virtual tool.

In step 4082, the outer surface of the virtual tool is divided into a plurality of surface elements (A).

In step 4083, for each of the tool boundary points that is located between an adjacent pair of the tissue voxels, the tool boundary point is set as a first type.

In step 4084, for each of the tool boundary points that is located between one of the tissue voxels and one of the object boundary points corresponding to the corresponding adjacent pair of the tissue and null voxels, the tool boundary point is set as the first type.

In step 4085, for each of the surface elements (A), upon determining that a closest one of the tool boundary points relative to the surface element (A) is the first-type, an element force component is determined according to the feed direction, the feed distance, and an area of the surface element (A).

In step 4086, the element force components obtained in step 4085 are summed to result in the force information. The force information essentially includes strength of three direction force components F_{X}, F_{Y}, F_{Z} along the first, second and third axes (X, Y, Z).

Specifically, in step 4085, the element force component includes first, second, third and fourth element sub-components. The first element sub-component is in a direction opposite to a rotation direction of the virtual tool. The second element sub-component is in a direction orthogonal to the rotation direction. The third element sub-component is in a direction opposite to a longitudinal axis of the virtual tool. The fourth element sub-component is in a direct ion opposite to the feed direction. Strengths of the first, second, third and fourth element sub-components are determined according to the following equations:

F_{tan g}=KₕdAfᵣₐₜₑ

F_{radial}=KᵣdAfᵣₐₜₑ

Fₐₓᵢₐₗ=KₐdAfᵣₐₜₑ

Fₜᵣᵤₛₜ=KₜdAfᵣₐₜₑ

where F_{tan g} represents the first element sub-component, F_{radial} represents the second element sub-component, Fₐₓᵢₐₗ represents the third element sub-component, Fₜᵣᵤₛₜ represents the fourth element sub-component, Kₕ, Kᵣ, Kₐ and Kₜ represent predefined force parameters in the predefined force parameter set respectively corresponding to the first, second, third and fourth element sub-components, dA represents the area of the surface element (A), and fᵣₐₜₑ represents a feed rate of the virtual tool and is a product of the feed distance and the predefined haptic period.

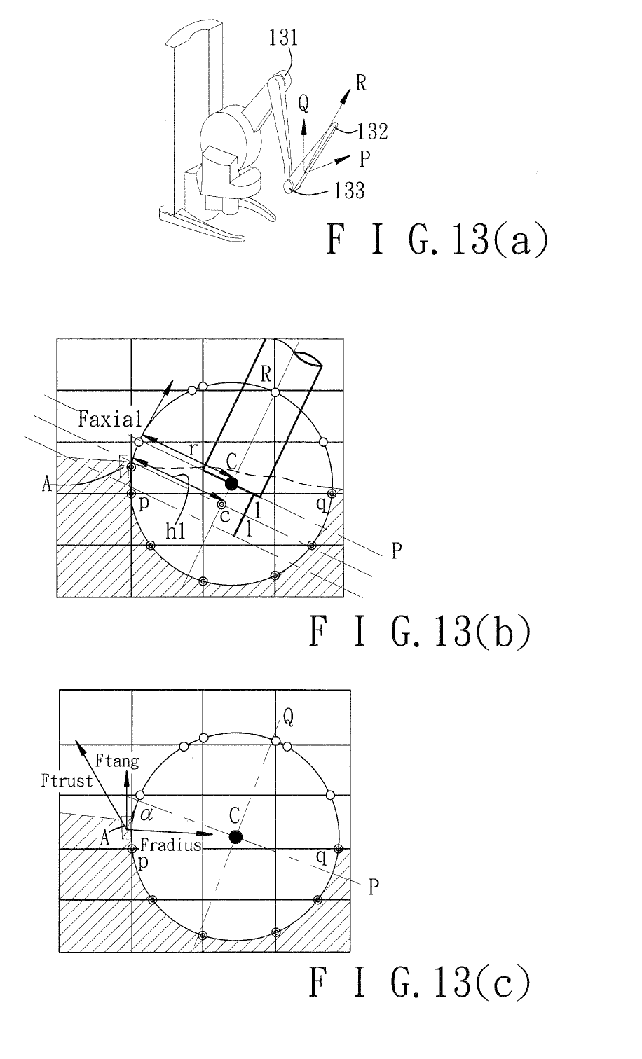

With reference to FIG. 13(a), recalling that the current center position of the sensing ball 133 is given in the device coordinate system that is different from the object coordinate system, and that a conversion into the object coordinate system is required, the device coordinate system is defined by fourth, fifth and sixth axes (P, Q, R), where the sixth axis (R) is a longitudinal axis defined by the handle 132 of the haptic simulating device 13, and is also the longitudinal axis of the virtual tool. Accordingly, in reality, the force information including the strength of three direction force components F_{X}, F_{Y}, F_{Z} along the first, second and third axes (X, Y, Z) has to be converted into the device coordinate system in terms of three directional force components F_{P}, F_{Q}, F_{R} in the fourth, fifth and sixth axes (P, Q, R) in order for the haptic simulating device 13 to generate the force correspondingly.

With reference to FIG. 13(b) and FIG. 13(c), assuming that the virtual tool is divided into a plurality of cross sections along the sixth axis (R) at equal distances (dl), and a surface segment between an adjacent pair of the cross sections is further divided at equal angles (dα) in a plane defined by the fourth and fifth axes (P, Q) with respect to the sixth axis (R), then the area of the surface element (A) is determined by the following equation:

dA=h₁×dα×dl

In addition, a position of surface element (A) is determined by the following equation:

position(A)=C−lR+h₁P+h₁M(α)

where C represents a position vector of the current center position of the virtual tool, l represents a distance vector from the current center position to a center c of the cross-section of the virtual tool that the surface element (A) is associated with, h₁ represents a radius of the cross-section that the surface element (A) is associated with, M represents a rotation matrix about the sixth axis (R), α represents an angular position of the surface element (A) with respect to the fourth axis (P), P represents a vector along a positive direction of the fourth axis (P), and R represents a vector along a positive direction of the sixth axis (R).

The position and area of each surface element are predetermined, and the position of each surface element is converted into the object coordinate system in terms of the first, second and third axis (X, Y, Z).

After the element force components obtained in step 4085 are summed in step 4086 to result in the force information, the force information is converted into the device coordinate system in terms of the fourth, fifth and sixth axes (P, Q, R) in order for the haptic simulating device 13 to generate the force.

It should be noted herein that in other embodiments of the present invention, instead of determining the current tool subvolume, step 403 can be changed to determining a tool swept subvolume of the object volume in the object coordinate system based on the current center position of the virtual tool, the previously obtained center position of the virtual tool, and the predefined dimensions of the virtual tool in the object coordinate system. The tool swept subvolume encloses both the virtual tool in the current haptic step and the virtual tool in the previous haptic step. FIG. 18 is a 2D image illustrating for simplicity one way of determining the tool swept subvolume. In still other embodiments of the present invention, step 404 may be changed to determining whether there is at least one tissue voxel within the current tool subvolume that is not present in a previously determined tool subvolume, which is temporally spaced apart from the current tool subvolume by the predefined haptic period, in order to save computation time for step 404.

It should be further noted herein that the method of the present invention may also apply to an object volume whose voxels are categorized into more than two types (not just tissue voxel and null voxel). For instance, the tissue voxels may represent one of skin voxel, bone voxel, muscle voxel, nerve voxel, etc., the labelling of which is determined based on the gray-scale values corresponding thereto. In such instance, there will be different sets of predefined force parameters for different types of the tissues for use in force information computations, and the image constructed from the voxel data sets will have different colours.

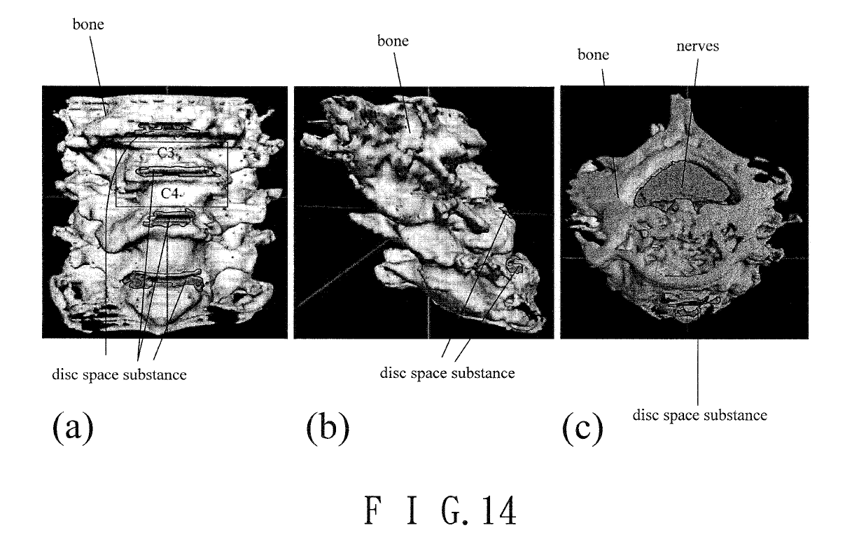

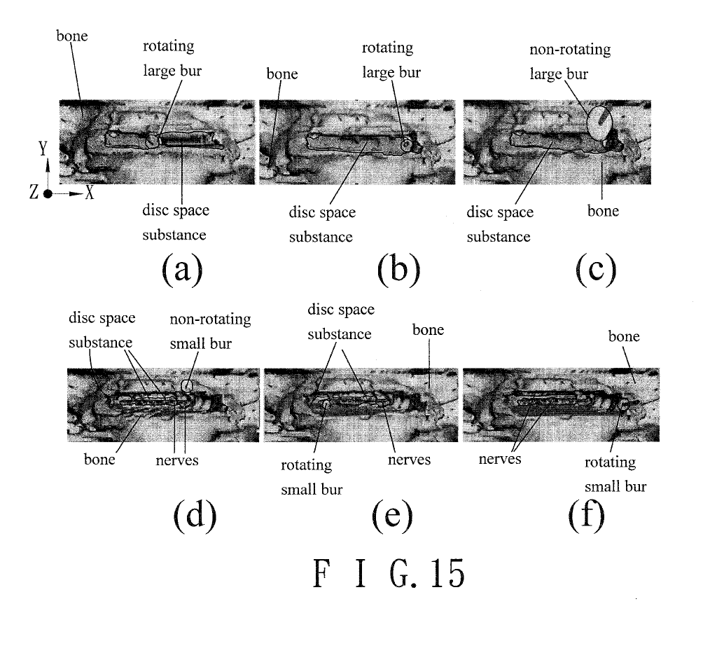

Referring to FIG. 14, an exemplary application of the method for generating the real-time haptic response information according to the present invention is performed on a spinal surgery simulation for anterior decompression. This surgery simulation includes the following steps: discectomy of disc space substance between the third and fourth cervical vertebras (C3, C4), osteotomy of the endplates of the third and fourth cervical vertebras (C3, C4), and bone grafting for fusing the third and fourth cervical vertebras (C3, C4). In this exemplary application, the image database 24 contains 95×256×256 image data sets, and is generated from 95 image slices that are obtained by linear interpolation from 45 CT image slices. An interval between each adjacent pair of the image slices is 1 mm. The object volume contains a segment of the spine, with bone voxels, nerve voxels, and disc space substance voxels. FIGS. 14(a)˜14(c) respectively illustrate front, side and top views of image construction of the object volume.

Referring to FIGS. 15(a)˜15(c), which are enlarged views of the third and fourth cervical vertebra (C3, C4) in the image construction of the object volume, a burring tool with a larger dimension (hereinafter referred to as the “large bur”) is initially used as the virtual tool for gross removal of the disc space substance and a portion of the end plates of the third and fourth cervical vertebras (C3, C4). In particular, with reference to FIG. 15(a) and FIG. 15(b), the large bur is moved back and forth along the first axis (X) in between the third and fourth cervical vertebras (C3, C4). Subsequently, the large bur is moved along the third axis (Z) to remove the rightmost portion of the disc space substance, the result of which is shown in FIG. 15(c).

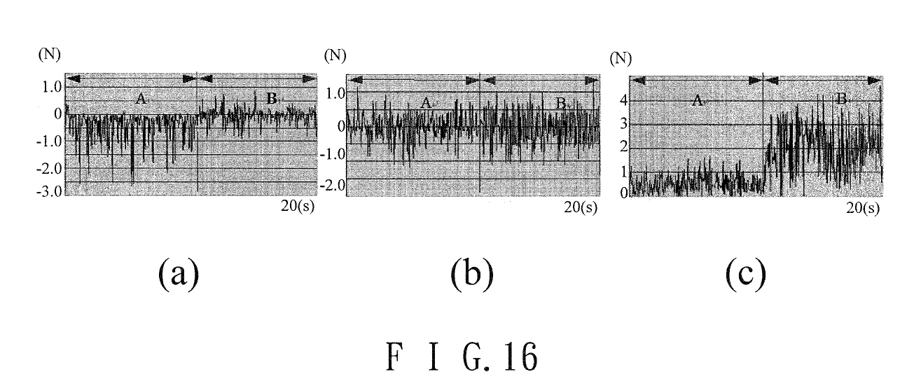

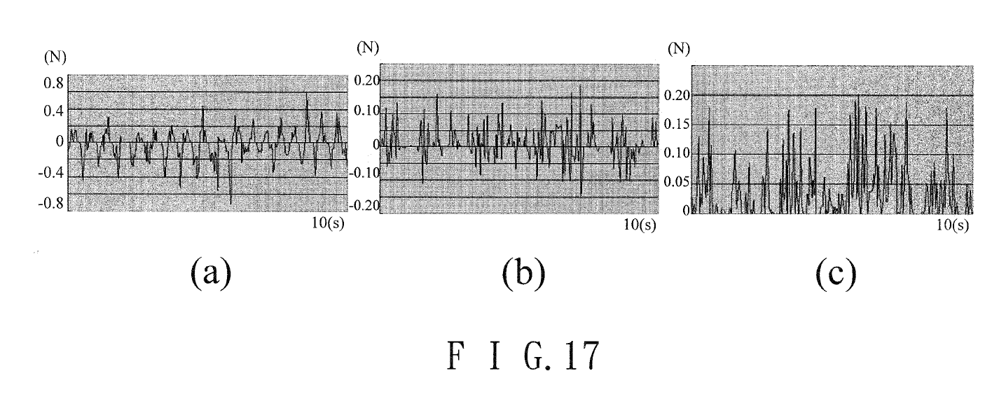

FIGS. 16(a)˜16(c) respectively show the strengths of the three directional force components F_{X}, F_{Y}, F_{Z} of the force to be generated by the haptic simulating device 13 (assuming that no conversion from the object coordinate system to the device coordinate system is necessary) during tissue removal by the large bur, where segments labeled (A) correspond to FIGS. 15(a)˜15(b) when the large bur is moved back and forth along the first axis (X), and segments labeled (B) correspond to FIG. 15(c) when the large bur is moved along the third axis (Z). Strengths of the directional force component F_{X} in the segment labeled (A) are mainly negative because the fourth element sub-components Fₜᵣᵤₛₜ of most contributing surface elements mainly contribute to the negative direction of the first axis (X). Strengths of the direction force component F_{Z} in the segment labeled (A) are all positive because the third element sub-components Fₐₓᵢₐₗ of all contributing surface elements are all in the third direction (Z). Strengths of the directional force component F_{Z} in the segment (B) are greater than those in the segment (A) because the fourth element sub-components Fₜᵣᵤₛₜ of most contributing surface elements mainly contribute along the third axis (Z).

With reference to FIGS. 15(d)˜15(f), a burring tool with a smaller dimension (hereinafter referred to as the “small bur”) is then used as the virtual tool for delicate removal of the remaining disc space substance and for smoothing the surfaces of the end plates of the third and fourth cervical vertebras (C3, C4), especially the end plate of the fourth cervical vertebra (C4). FIG. 15(d) shows the rugged surface of the end plates after tissue removal by the large bur. As shown in FIG. 15(e), the small bur is rotating and begins to remove the remaining disc space substance and smooth out the surfaces of the endplates. As shown in FIG. 15(f), the endplate surfaces are smoothened, and the disc space substance is completely removed after operating with the small bur.

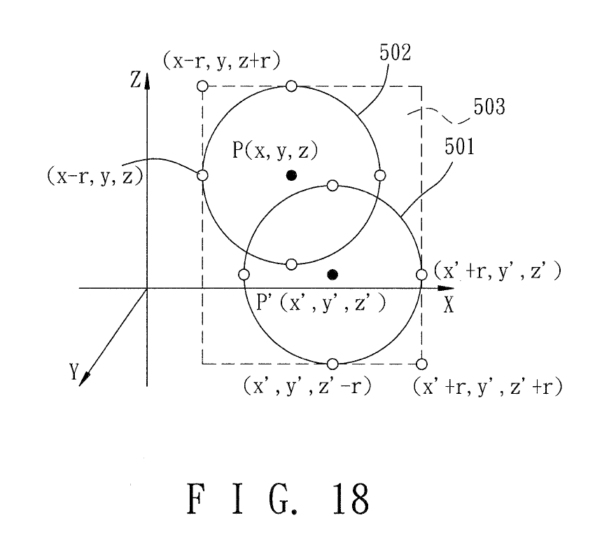

FIGS. 17(a)˜17(c) respectively show the strengths of the three directional force components F_{X}, F_{Y}, F_{Z} of the force to be generated by the haptic simulating device 13 (assuming that no conversion from the object coordinate system to the device coordinate system is necessary) during tissue removal by the small bur. Strengths of the directional force component F_{X} oscillates between positive and negative as the frequency of rotation of the small bur as contributed by the fourth element sub-components Fₜᵣᵤₛₜ of contributing surface elements. Strengths of the direction force components F_{Y}, F_{Z} are smaller than those of the directional force component F_{X} because the fourth element sub-components Fₜᵣᵤₛₜ of contributing surface elements have little contribution along the second and third axes (Y, Z). Strengths of the directional force component F_{Z} are all positive because the third element sub-components Fₐₓᵢₐₗ of most contributing surface elements and the fourth element sub-components Fₜᵣᵤₛₜ of some contributing surface elements contribute along the third axis (Z).

In sum, the method for generating real-time haptic response information for a haptic simulating device can be employed in the medical field for training or rehearsing purposes in order for doctors to get acquainted with the reaction forces that would be encountered during surgical operations so as to enhance stability during actual surgical operations. Due to the use of the distance-level values for representing the positions of the object boundary points, the boundary of the tissue in the object volume can be more precisely determined, and even very slight movement of the virtual tool between haptic steps can be detected. In addition, in confining determination of whether the virtual tool is in contact with the tissue in the object volume and of the changes made to the tissue (i.e., voxels and object boundary points) in the object volume, computation time and cost are significantly reduced because computation is limited within the current tool subvolume, instead of the whole object volume. Moreover, four element sub-components are taken into consideration in determining the element force component for each surface element, respectively in a direction opposite to a rotation direction of the virtual tool, a direction orthogonal to the rotation direction, a direction opposite to a longitudinal axis of the virtual tool, and a direction opposite to the feed direction, making the force information generated by the method of the present invention more accurate as compared to the prior art.

While the present invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating real-time haptic response information for a haptic simulating device during a surgery simulation performed on an object volume by a virtual tool that is associated with the haptic simulating device, the object volume being defined in a three-dimensional object coordinate system, and including a plurality of uniformly-spaced-apart voxels, each of the voxels being labeled as one of a tissue voxel and a null voxel, and having a voxel center position expressed by integer coordinate components in the object coordinate system, the object volume further including a plurality of object boundary points, each of which is located between a corresponding adjacent pair of the tissue and null voxels, the method comprising the steps of:
(a) obtaining a current center position of the virtual tool in the object coordinate system, the current center position being temporally spaced apart from a previously obtained center position of the virtual tool by a predefined haptic period;
(b) determining a current tool subvolume of the object volume in the object coordinate system based on the current center position of the virtual tool and predefined dimensions of the virtual tool in the object coordinate system; and
(c) upon determining that the current tool subvolume has at least one of the tissue voxels, performing the sub-steps of:
(c-1) determining positions of a plurality of tool boundary points within the current tool subvolume based on the current center position of the virtual tool and the predefined dimensions of the virtual tool,
(c-2) updating labeling of the voxels within the current tool subvolume and replacing an original set of the object boundary points within the current tool subvolume with a new set of the object boundary points with reference to the positions of the tool boundary points determined in sub-step (c-1), and the voxel center positions of at least one of the tissue and null voxels within the current tool subvolume, and
(c-3) providing force information of a force to be generated by the haptic simulating device according to a feed direction from the previously obtained center position of the virtual tool to the current center position of the virtual tool, a feed distance between the current and previously obtained center positions of the virtual tool, the predefined dimensions of the virtual tool, a relationship between the positions of the tool boundary points and the voxels within the current tool subvolume, and a predefined force parameter set.

2. The method as claimed in claim 1, the object coordinate system being defined by first, second and third axes that are orthogonal to each other, the method further comprising, prior to step (a):
generating the object volume based on a volume database containing a plurality of voxel data sets, each of which represents a corresponding one of the voxels in the object volume, and contains a first-axis coordinate component, a second-axis coordinate component, a third-axis coordinate component, and a voxel label, the first, second and third-axis coordinate components cooperating to indicate the voxel center position of the corresponding one of the voxels, the voxel label indicating the corresponding one of the voxels to be one of the tissue and null voxels.

3. The method as claimed in claim 2, wherein the voxel data set corresponding to one of the voxels in an adjacent pair of the tissue and null voxels further contains a distance-level value, the distance-level value indicating a distance between the voxel center position of said one of the voxels in the adjacent pair of the tissue and null voxels and one of the object boundary points that is located between the adjacent pair of the tissue and null voxels in a corresponding one of six directions along the first, second and third axes.

4. The method as claimed in claim 3, wherein the distance-level value is determined according to gray-scale values of the adjacent pair of the tissue and null voxels.

5. The method as claimed in claim 2, wherein the voxel label of each of the voxel data sets is determined by comparing a gray-scale value corresponding to the voxel represented by the voxel data set with a predefined threshold value.

6. The method as claimed in claim 3, wherein:
the current tool subvolume has the shape of a rectangular parallelepiped; and
in sub-step (c-1), the position of each of the tool boundary points is determined by locating a corresponding intersection between an outer surface of the virtual tool that is determined from the current center position of the virtual tool and the predefined dimensions of the virtual tool, and a corresponding line that is parallel to one of the first, second and third axes, and that has integer coordinate components in the other two of the first, second and third axes.

7. The method as claimed in claim 6, wherein, in sub-step (c-1), for each of the tool boundary points, the line corresponding thereto passes through the center position of at least one of the tissue voxels.

8. The method as claimed in claim 6, wherein a line segment bounded by two of the tool boundary points respectively having the greatest and smallest coordinate component values in said one of the first, second and third axes that the line segment is parallel to is defined as a tool extent, and sub-step (c-2) includes the following sub-sub-steps that are conducted with respect to each of the lines that correspond to the tool boundary points:
(c-2-1) upon determining that at least one of the tool boundary points on the line is located between an adjacent pair of the tissue voxels on the line, removing the object boundary points on the line, setting said at least one of the tool boundary points as corresponding new object boundary points, and replacing the tissue voxels located within the tool extent with the null voxels;
(c-2-2) upon determining that none of the tool boundary points on the line is located between an adjacent pair of the tissue voxels on the line, for each of the tool boundary points located between a corresponding adjacent pair of the tissue and null voxels on the line, comparing a tool boundary distance between the tool boundary point and one of the tissue and null voxels in the corresponding adjacent pair with an object boundary distance between said one of the tissue and null voxels in the corresponding adjacent pair and a corresponding one of the object boundary points located between the corresponding adjacent pair of the tissue and null voxels on the line; and
(c-2-3) if it is determined in sub-sub-step (c-2-2) that the tool boundary distance is smaller than the object boundary distance, removing said corresponding one of the object boundary points on the line, setting the tool boundary point as a corresponding new object boundary point, and replacing the tissue voxels located within the tool extent with the null voxels.

9. The method as claimed in claim 8, wherein, in each of sub-sub-steps (c-2-1) and (c-2-3), each of the voxel data sets corresponding to one of the voxels in a corresponding adjacent pair of the tissue and null voxels that have the new object boundary point located therebetween is assigned with a new distance-level value based on the distance between the new object boundary point and said one of the voxels in a corresponding one of the six directions.

10. The method as claimed in claim 1, the virtual tool associated with the haptic simulating device being a ball-shaped rotatable burring tool, wherein:
in step (a), a current status of the virtual tool is obtained along with the current center position, the current status being one of rotating and non-rotating;
sub-steps (c-1), (c-2) and (c-3) are performed only if the current status of the virtual tool is rotating; and
if the current status of the virtual tool is non-rotating, and the current tool subvolume is determined to have at least one of the tissue voxels, force information of a force that is to be generated by the haptic simulating device in a direction opposite to the feed direction and that has a predefined strength is provided.

11. The method as claimed in claim 10, wherein sub-steps (c-1), (c-2) and (c-3) are performed only if the current status of the virtual tool is rotating, and if the feed distance is smaller than a feed distance threshold value.

12. The method as claimed in claim 11, wherein sub-step (c-3) includes the sub-steps of:
(c-3-1) determining an outer surface of the virtual tool according to the current center position of the virtual tool and the predefined dimensions of the virtual tool;
(c-3-2) dividing the outer surface into a plurality of surface elements;
(c-3-3) for each of the tool boundary points that is located between an adjacent pair of the tissue voxels, setting the tool boundary point as a first type;
(c-3-4) for each of the tool boundary points that is located between one of the tissue voxels and one of the object boundary points corresponding to the corresponding adjacent pair of the tissue and null voxels, setting the tool boundary point as the first type;
(c-3-5) for each of the surface elements, upon determining that a closest one of the tool boundary points relative to the surface element is the first-type, determining an element force component according to the feed direction, the feed distance, and an area of the surface element; and
(c-3-6) summing the element force components obtained in sub-sub-step (c-3-5) to result in the force information.

13. The method as claimed in claim 12, wherein, in sub-sub-step (c-3-5), the element force component includes first, second, third and fourth element sub-components, the first element sub-component being in a direction opposite to a rotation direction of the virtual tool, the second element sub-component being in a direction orthogonal to the rotation direction, the third element sub-component being in a direction opposite to a longitudinal axis of the virtual tool, the fourth element sub-component being in a direction opposite to the feed direction, strengths of the first, second, third and fourth element sub-components being determined according to the following equations:
F_{tan g}=KₕdAfᵣₐₜₑ
F_{radial}=KᵣdAfᵣₐₜₑ
Fₐₓᵢₐₗ=KₐdAfᵣₐₜₑ
Fₜᵣᵤₛₜ=KₜdAfᵣₐₜₑ
where F_{tan g} represents the first element sub-component, F_{radial} represents the second element sub-component, Fₐₓᵢₐₗ represents the third element sub-component, Fₜᵣᵤₛₜ represents the fourth element sub-component, Kₕ, Kᵣ, Kₐ and Kₜ represent predefined force parameters in the predefined force parameter set respectively corresponding to the first, second, third and fourth element sub-components, dA represents the area of the surface element, and fᵣₐₜₑ represents a feed rate of the virtual tool and is a product of the feed distance and the predefined haptic period.
